(19) United States
(12) Patent Application Publication
(10) Pub. No.: US 2012/0174021 A1
(43) Pub. Date: Jul. 5, 2012

(54) SYSTEMS AND METHODS FOR DISPLAYING ANDROID APPLICATIONS LAUNCHERS IN WEBTOP APPLICATION TRAY

(75) Inventor: Parikshit H. Dharawat, Sunnyvale, CA (US)

(73) Assignee: Motorola, Inc., Schaumburg, IL (US)

(21) Appl. No.: 12/984,227

(22) Filed: Jan. 4, 2011

(51) Int. Cl. G06F 3/048

(52) U.S. Cl. 715/779

(57) ABSTRACT

Systems and methods are disclosed to display an application tray having a first and second application launchers from two completely native environments operating on a device. First, in a first portion of the application tray, the device displays a first icon corresponding to a first application running in a first environment. Second, in a second portion of the application tray, the device displays a second icon corresponding to a second application running in a second environment. Third, the device detects a selection on one of the displayed first and second icons. In the fourth step, the device launches the first application in a window when the first icon is selected. Finally, the device displays the window on top of other open windows on the display. The first environment and the second environment interact with a kernel. The second environment is a primary environment operating on the device.

### FIELD OF THE DISCLOSURE

The present invention relates generally to mobile device systems and, more particularly, to mobile systems including multiple environments as described below.

### BACKGROUND

Operating systems are designed and typically optimized based on specific applications and user desired performance. It is often desirable to have applications of one type of operating system available to another operating system.

General-purpose computer operating systems such as Linux™ and Windows™ have an extensive set of features such as file systems, device drivers, applications, libraries, etc. Such operating systems allow concurrent execution of multiple programs, and attempt to optimize the response time (also referred to as latency time), and CPU usage, or load, associated with the servicing of the concurrently executing programs. Unfortunately, however, such operating systems are not generally suitable for embedded real-time applications, such as for mobile computing devices. Under certain circumstances it would be desirable for a mobile computing device to have the performance associated with a mobile-specific embedded operating system and features of a general-purpose operating system.

Linux, for example, is a well known general purpose desktop operating system with many desirable features for modern devices including modern operating systems features, numerous development tools, networking, etc. However, Linux was not designed to be an embedded or real time operating system. Many modern devices, such as, without limitation, set top boxes, mobile phones and car navigation systems require not only the features of a general purpose operating system such as Linux, but also the features of an embedded or real time operating system, including real time performance.

Given that Linux-based operating systems offer some benefits but that other types of operating systems offer other benefits, particularly in the context of certain types of devices such as mobile devices, it would be desirable if somehow multiple operating systems could be implemented on a single device so that the benefits of each different type of operating system could be achieved in relation to that device. Running multiple operating systems on a single device has been accomplished through virtualization techniques, such as (for example) found in VMware™, VirtualBox™, QEMUTM, etc. However, when using virtualization a complete computer is emulated and one or more software stacks are operated in the emulated computing device. Emulation is susceptible to high overhead costs, and consequently conventional virtualization techniques are often impractical, especially again in the context of certain types of devices such as mobile devices.

Therefore, a new type of mobile device system is introduced to enjoy benefits of multiple distinct operating environments with less overhead costs than would otherwise be the case using conventional virtualization techniques. It would be desirable to develop an application tray to display and launch applications from multiple distinct operating environments so that a user can launch any application by selecting the corresponding icons on the application tray.

### BRIEF DESCRIPTION OF THE DRAWINGS

FIG. 1 is an exemplary illustration of a mobile device in the disclosure;

FIG. 2 is a block diagram representing in schematic form exemplary components of the device of FIG. 1, including an exemplary mobile device system that has multiple environments;

FIG. 3 is a block diagram representing in schematic form certain additional exemplary component;

FIG. 4 is a block diagram representing processes pertaining to an exemplary run-time coexistence schema;

FIG. 5 is a flow chart showing steps of an exemplary booting sequence for the mobile device system of FIG. 2;

FIG. 6A is an illustration of one embodiment of the GUI of the device of FIG. 1;

FIG. 6B is a detailed illustration of the application tray of the GUI of FIG. 5; and

FIG. 7 is a flow chart showing steps of displaying the application tray.

### DETAILED DESCRIPTION OF THE DRAWINGS

It is envisioned that it would be advantageous to have an mobile device system including both a first application-middleware environment and a second application-middleware environment that each communicate directly with a single kernel running directly upon a mobile computing device's hardware. In at least some embodiments, one or both of the first and second application-middleware environments are Linux-based application-middleware environments. Also, in at least some embodiments, one or both of the first and second application-middleware environments are embedded. In one exemplary embodiment, each of the first and second application-middleware environments is an embedded Linux-based application-middleware environment, and both of the application-middleware environments communicate directly with a single Linux kernel running directly upon a computing device's hardware (e. g., the hardware of a mobile device).

In the first embodiment, a method for displaying an application tray on a device is disclosed. In the first step, the device displays, in a first portion of the application tray on a display of the device, icons corresponding to applications running and capable to be launched in a first environment operating on the device. In the second step, the device displays, in a second portion of the application tray on the display of the device, icons corresponding to applications running and capable to be launched in a second environment operating on the device. In the third step, the device detects a selection on one of the displayed first and second icons. In the fourth step, the device launches the first application in a window when the first icon is selected. Finally, the device displays the window on top of other open windows on the display. The first environment and the second environment interact with a kernel operating on the device. The second environment is a primary environment operating on the device.

One embodiment discloses a device including a display and at least one processor configured to interact with the display and perform the following acts. In the first step, the device displays, in a first portion of the application tray on a display of the device, a first plurality of icons corresponding to a first plurality of applications running in a first environment operating on the device. In the second step, the device displays, in a second portion of the application tray on the display of the device, a second plurality of icons corresponding to a second plurality of applications running in a second environment operating on the device. Then the device launches one of the first plurality of applications in a first window when one of the first plurality of icons is selected. Finally, the device displays the first window on top of other open windows on the display. The first environment and the second environment interact with a kernel operating on the device. The second environment is a primary environment operating on the device.

Another embodiment discloses a mobile device including a display; at least one processor configured to interact with the display; and at least one storage device that stores a set of instructions to direct the at least one processor to perform the following acts. First, the device displays, in a first portion of the application tray on a display of the device, a first plurality of icons corresponding to a first plurality of applications running in a first environment operating on the device. Second, the device displays, in a second portion of the application tray on the display of the device, a second plurality of icons corresponding to a second plurality of applications running in a second environment operating on the device. Then the device launches one of the first plurality of applications in a window when one of the first plurality of icons is selected. Finally, the device displays the first window on top of other open windows on the display. The first environment and the second environment interact with a kernel operating on the device. The second environment is a primary environment operating on the device.

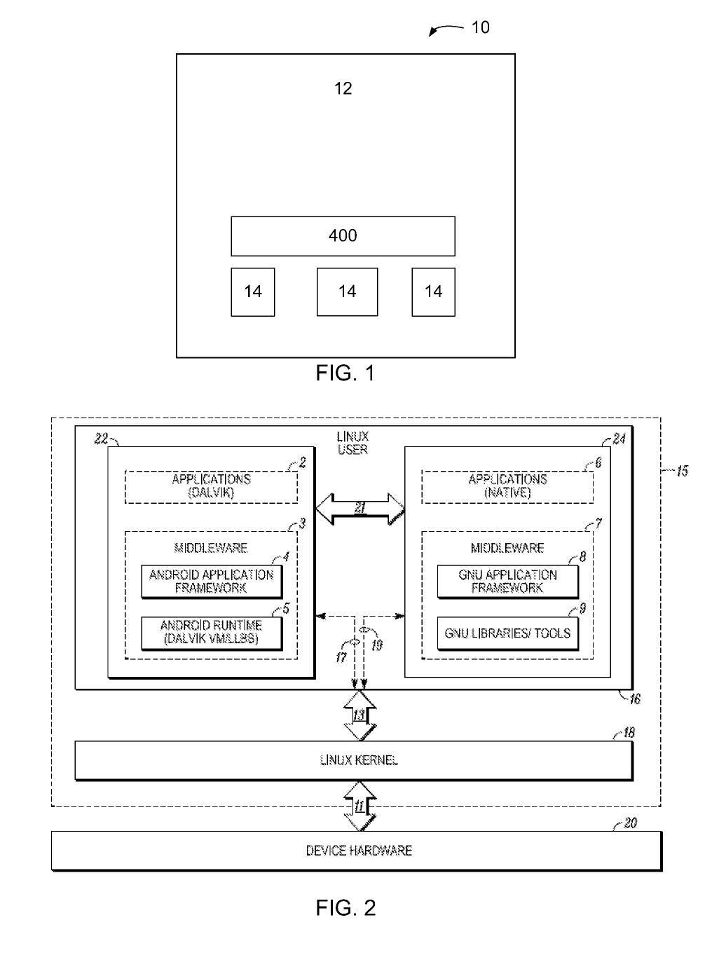

In FIG. 1, an exemplary illustration of a mobile computing device 10 is provided. The mobile device 10 includes a graphical user interface (GUI) 12 and a plurality of data input buttons 14. The mobile device 10 is selected from the group including, but not limited to, a mobile personal computer (PC), a netbook, a mobile telephone, a laptop computer, a handheld computer and a smart phone. Accordingly, the mobile device 10 includes communication features (not shown) to enable wireless or wire line communication with a remote device such as a wireless network. Although the computing device is mobile, it is intended to have significant computing power, with a processor speed in excess of 500 MHZ, although slower processors are not excluded. Considering the computing power, a user can connect the mobile device to a variety of peripheral devices. The peripheral devices are selected from a group including, but not limited to, display monitor, a laptop computer, a desktop computer, a tablet PC, a screen projector, a docking station, a television monitor, etc. The connection between the mobile device 10 and the peripheral device can be wireless or wire line.

Additionally, the mobile computing device 10 may also include a variety of added applications. The additional applications may be based upon the particular software and hardware environments that are selected for the device. By example, a compass function can be provided for orientation, an accelerometer function can be provided, in addition to telephony, Bluetooth and Wi-Fi stack for connectivity keyboard and touch screen function for enhanced interaction.

The present disclosure is directed to systems and methods for displaying an application tray 400 on the mobile computing device 10. The application tray 400 includes application launcher icons corresponding to applications in different application-middleware environments. The application tray 400 can launch the application in the corresponding first or second application-middleware environment when the displayed launcher icon is selected.

In FIG. 2, a block diagram is provided showing in schematic form particular components of the mobile device system that includes a GNU/Linux distribution or operating system (OS) 15 in communication with device hardware 20 as indicated by an arrow 11. Further as shown, the GNU/Linux OS 15 more particularly includes a Linux kernel 18 and a Linux user component 16 that are in communication with one another as indicated by an arrow 13. The Linux user component 16 is further shown to include a first application-middleware environment 22 and a second application-middleware environment 24 (hereinafter, the respective first and second application-middleware environments will more simply be referred to as the first and second environments, respectively). More particularly, as further indicated by arrows 17 and 19, respectively, each of the first and second environments 22 and 24, respectively, of the Linux user component 16 is in communication with the single Linux kernel 18. In the present embodiment, the first environment 22 is an embedded environment intended for use in mobile devices, namely, an Android environment (additional description regarding Android can be found at http://www.openhandsetalliance.com, the website of the Open Handset Alliance, which is hereby incorporated by reference herein), while the second environment 24 is a standard GNU/Linux environment. In addition to the environments 22, 24 being capable of communications with the Linux kernel 18, those environments also communicate with each other, as represented by an arrow 21.

As will be described in further detail below, the multiple environments 22, 24 can operate and coexist independently of one another. This is not to say that the two environments 22, 24 are absolutely operationally independent in all respects. Indeed, to the extent that both environments 22, 24 interact with and compete for resources of the Linux kernel 18, the two environments are interdependent in that respect. Likewise, to the extent that the two environments 22, 24 are in communication with one another (e. g., as represented by the arrow 21), the two environments can operate in conjunction with one another in that manner as well. Nevertheless, for purposes of the present explanation, the two environments 22, 24 are considered “independent” in the sense that each of the environments is capable of operating by itself even if the other of the environments was not present (and, indeed, each of the environments can be operationally independent before simultaneous implementation of both of the environments upon the same Linux kernel 18). Additionally, in at least some embodiments, the two environments 22, 24 can also be considered “independent” insofar as each of the two environments is of a different type (e. g., in terms of being embedded, etc.) and correspondingly serves different purposes in terms of the operations it performs and the functions it can achieve vis-a-vis the Linux kernel 18, the device hardware 20, and the outside world (e. g., users and/or other devices).

Although shown to be a GNU/Linux OS 15 with the Linux kernel 18 and Linux user component 16, the present invention is intended to encompass alternate embodiments in which other types of operating systems, kernels, and other operating system components are employed, and the present invention is not intended to be limited only to Linux-based systems. Likewise, notwithstanding that in the present embodiment the first environment 22 is the Android environment and the second environment 24 is the standard GNU/Linux environment, in other embodiments, other environments can be employed instead of the Android environment. Depending upon the embodiment, such other environments can be but need not be embedded environments, and/or can be but need not be suitable for use in mobile devices. Also, depending upon the embodiment, environments and/or operating systems that operate in real time or do not operate in real time can be employed. Further, while two environments 22, 24 are shown in FIG. 1, the present invention is intended to encompass additional embodiments in which more than two environments are present (and can operate and coexist independently of one another, where the manner of independence of the environments is as described above).

Still referring FIG. 1, in at least the present embodiment in which the first environment 22 is the Android environment and the second environment 24 is in accordance with the standard GNU/Linux distribution, those environments can more particularly encompass several software components as shown. With respect to the first (Android) environment 22, that environment includes applications 2 (e. g., user applications), which are in the Dalvik language, and middleware 3, with the applications and middleware being bundled together. The middleware 3 as shown includes an Android application framework 4 and Android run-time programming 5. Although not shown, in at least some embodiments, the middleware 3 of the first environment 22 can also include other components, for example, a radio interface layer, and/or components allowing for global positioning system (GPS) functioning. In some embodiments, the middleware 3 (or portions thereof) is released under an Apache license. As for the applications 2, these applications are managed by the Android application framework 4 and interpreted in the Android run-time programming 5 (more particularly, an interpreter established by the run-time programming translates the applications at run-time). The applications 2, which can be understood to include stacks and other application components, are separate from one another and include computer instructions that are recognizable by the middleware 3 atop which the applications 2 are juxtaposed.

The Android run-time programming 5 in particular makes use of a Dalvik register-based virtual machine (VM) as well as Dalvik libraries and tools. The VM interacts with the Dalvik libraries and tools, as well as with other components such as the Linux kernel 18. The Dalvik (Android implemented) libraries are proprietary libraries that are implemented on top of Linux kernel 18. The functionality implemented by way of the Dalvik libraries is sufficient to run the Dalvik VM, but are based on a subset of the libraries supported by GNU/Linux. The Dalvik register-based virtual machine (including the Dalvik language) is employed in the present embodiment because it has been optimized for implementation in mobile devices. Dalvik was conceived as an instrument to enable a large population of Java programmers to easily develop applications on relatively computationally-weak (compared to personal computers) mobile devices. Java is not the same as Dalvik. In particular, register-based virtual machines such as that provided by Dalvik are easier to optimize than stack-based architectures such as the Java virtual machine on a particular set of hardware. Also, Android/Dalvik replicates a complete middleware layer, rather than merely a byte-code interpreter (VM) as does Java. Nevertheless, while Dalvik is not Java, Dalvik and Java share a common syntax so that programmers can easily adapt their skills to develop Dalvik applications. Thus, although the applications 2 operated by the middleware 3 (and particularly by the Android run-time programming 5) are Dalvik-interpreted applications rather than Java-interpreted applications, the applications 2 are similar to Java-interpreted applications in that they are byte-code-interpreted applications.

As for the second (GNU/Linux) environment 24, that environment includes its own applications 6 (e. g., user applications) coupled to middleware 7, with the middleware including both a GNU application framework 8 and GNU libraries/tools 9. The libraries/tools 9 can include a variety of components including, for example, libraries such as Qt or GTK (GIMP Toolkit) libraries useful for the display of information on a GUI, as well as other libraries/tools discussed in further detail below. Although not shown, the middleware 7 can include numerous other types of particular software components including, for example, one or more desktop environments such as GNOME, Enlightenment, Xfce, Fluxbox, LXDE and KDE, and/or a Gstreamer multimedia framework, and/or an X11 Window manager. As for the applications 6, these more particularly can be native applications in the sense that the executable code of those applications correspond to the instruction set architecture of the Linux kernel 18 and/or the device hardware 20. As with the applications 2, each of the applications 6 can also be understood to include its own respective stacks and other application software components that are separate from those of the other applications 6, and include computer instructions that are recognizable by the middleware 7 atop which the applications 6 are juxtaposed. In embodiments where the middleware 7 includes one or more of the software components discussed above (e. g., the aforementioned desktop environments), one or more of the applications 6 can be coupled to those components of the middleware.

In FIG. 2, the second environment 24 in combination with the Linux kernel 18 more particularly takes the form of an Ubuntu® Linux stack (additional description regarding Ubuntu can be found at www.ubuntu,com, sponsored by Canonical Ltd. of the United Kingdom, which is hereby incorporated by reference herein). For simplicity of description below, the second environment 24 is hereinafter referred to as an Ubuntu environment (albeit Ubuntu technically also encompasses that Linux kernel as well as the environment 24). In the present embodiment, the second environment 24 (and particularly the middleware 7 of that environment) additionally is capable of supporting a multiplicity of logical memory (data) partitions, while the first environment 22 only has a single logical memory partition in addition to providing system components. Notwithstanding the above description, in alternate embodiments it is possible that the second environment 24 may only have one logical memory partition, and/or that one or more other environments may also or instead be configured to support multiple logical memory partitions.

Notwithstanding the above description in which the first environment 22 is an Android environment and the second middleware system environment 24 is an Ubuntu environment, a variety of other types of environments can also or alternatively be employed including, for example, standard Linux-based environments, Symbian (Symbian Foundation Ltd., www.symbian.com) environments, and Windows-based environments (e. g., Windows and Windows Mobile). In at least some such embodiments, the environments are not Linux-based environments and correspondingly the environments can be implemented in conjunction with different types of kernels other than a Linux-based kernel (this can be the case, for example, with respect to Symbian or Windows-based environments as mentioned above). As already noted above, while the present embodiment particularly envisions the presence of two environments interacting with the same Linux kernel 18, in alternative embodiments it is envisioned that greater than two environments of any of a variety of types can independently coexist on the same Linux kernel 18 (or other core/kernel).

The device hardware 20 can include a variety of hardware devices, For example, the device hardware 20 can include a memory storage device (not shown) coupled to a processor (not shown), which stores computer executable instructions that are configured to perform various functions and operations, some of which are described herein. Also for example, the device hardware 20 can in addition (or instead) include any of a variety of other components/resources, such as cellular Bluetooth and/or Wi-Fi transceivers or radios, keyboards, other input devices such as a mouse and/or touch screens, memory sub-systems, audio amplifiers, output devices such as speakers and/or video screens, hardware accelerators, IP sockets, etc. The Linux kernel 18 allocates resources of the mobile device by connecting and managing interaction between the physical world of the device hardware 20 and the respective middleware 3, 7 of the environments 22, 24, respectively. The software components encompassed by the respective middleware 3, 7 (again, e.g., the application frameworks 3, 8, run-time programming 5, and/or GNU libraries/tools 9) are often referred to as the middleware because they are logically interposed between the kernel and software applications 2, 6, respectively. The purpose of the respective middleware 3, 7 is to orchestrate interaction between the device hardware 20 (physical world) and the applications 2, 6, respectively.

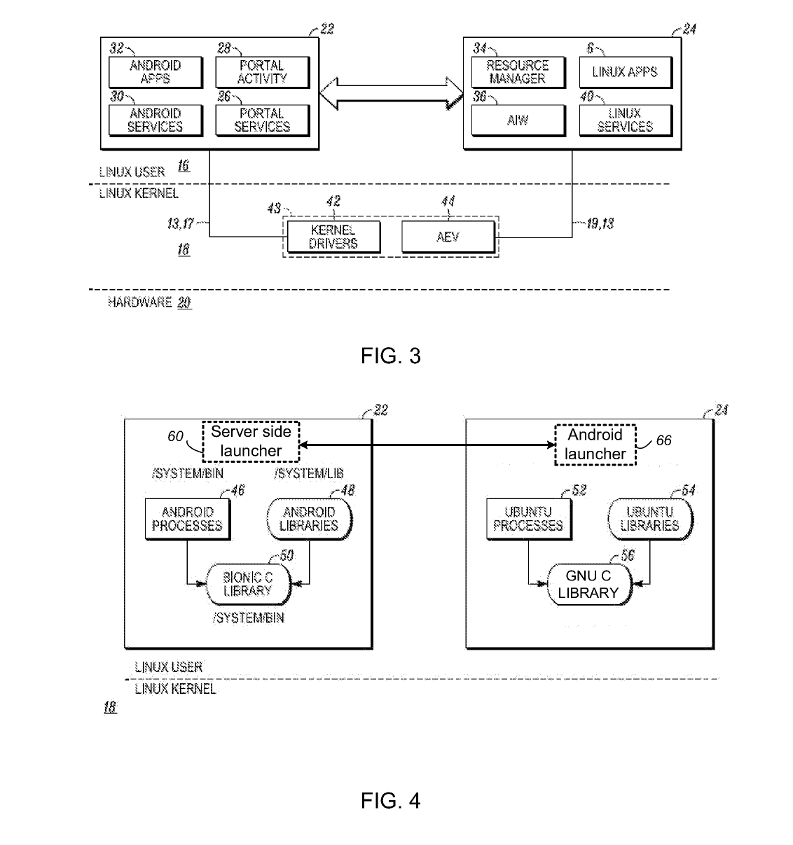

In FIG. 3, the device hardware 20 is again shown to be in communication with the Linux kernel 18 that is in communication with the Linux user component 16, and the Linux user is again shown to include the first (Android-based) environment 22 and the second (Linux-based) environment 24. Further as shown, the kernel 18 particularly includes several modules 43, which include a set of kernel drivers 42 and an Android event (AEV) module 44 (which is described in more detail below). Included among the drivers 42 are device drivers (e. g., input device drivers) for components of the device hardware 20. Additionally, while not shown in FIG. 2, FIG. 3 more particularly shows the first environment 22 as including a portal service module 26, a portal activity module 28, an Android services module 30, and an Android applications module 32. The modules 28 and 32 can be considered to be among the applications 2 of the first environment 22 as shown in FIG. 2, while the modules 26 and 30 can be considered portions of the middleware 3 of that environment. Also, FIG. 3 more particularly shows the second environment 24 as including an arbiter or resource manager 34, an Android in a window (AIW) module 36, and a Linux services module 40. The modules 34, 36 and 40 can be considered portions of the middleware 7 of FIG. 2. The applications 6 of FIG. 2 are additionally shown in FIG. 3 as Linux applications (potentially the AIW module 36 can also be considered one of the applications 6).

The various modules 26, 28, 30, 34, 36 and 40 are configured to serve particular functions. The AIW module 36 in particular is configured to display a first environment application window on the GUI 12 while the second environment 24 is the primary environment. The AEV 44, which as mentioned above is a kernel module, operates in conjunction with the AIW module 36 and in particular takes absolute coordinate and keyboard events from AIW 36 and passes them to an event hub. With respect to the portal service module 26, that module contains a set of instructions configured to allow service for the first environment 22 and directs all communication with the resource manager 34. While the mobile device 10 is operating, the portal service module 26 is preferably running at all times. Additionally, the portal service module 26 is connected to activity associated with the portal activity module 28, as well as first environment 22 broadcast events. As already mentioned, the portal activity module 28 is an application, or set of computer executable instructions. The portal activity module 28 more particularly represents a second environment 24 application located on the first environment 22 stack. By example, if the second (Linux-based) environment 24 is the Ubuntu environment, the portal activity module 28 can represent a specific Ubuntu application, and when the portal activity module 28 has focus, Ubuntu is in view through the GUI 12.

Generally speaking, numerous applications can run simultaneously, also referred to as a stack of running applications, within any given environment. Logically speaking, the topmost application is deemed to have “focus.” Where multiple applications are available for interaction with a user (e. g., where multiple windows corresponding respectively to multiple applications are shown on a display such as the GUI 12), that one of the applications which is currently interacting with the user in terms of being configured to receive input commands or signals from the user at a given time can be considered the application having “focus.” Notwithstanding the above description, in at least some embodiments of the present invention, while the second environment 24 is capable of causing the simultaneous display (e.g., on the GUI 12) of multiple windows corresponding to multiple applications, the first environment 22 does not have this capability. Rather, in such embodiments, the first environment is only able to cause the display (e.g., on the GUI 12) of a single window corresponding to a single application at any given time.

As discussed above, the co-existing environments 22, 24 within the operating system 15 communicate with each other as indicated by the arrow 21 and also communicate with the same Linux kernel 18 as indicated by the arrows 13, 17 and 19 of FIG. 2. Because (also as noted above) Android/Dalvik replicates a complete middleware layer, rather than merely a byte-code interpreter (VM) as does Java, absent the taking of appropriate steps there is a possibility of conflict in the operation of the middleware 3 and the middleware 7 of the first and second environments 22 and 24, respectively, in terms of the allocation of resources/physical assets controlled through the Linux kernel 18. To avoid such conflicts, the resource manager 34, which is part of the second environment 24, communicates directly with the portal service module 26, which is part of the first environment 22. Further, the portal service module 26, which is part of the first environment 22, communicates directly with the resource manager 34. The resource manager 34 is a set of instructions configured to manage the resources shared by the first environment 22 and second environment 24. The shared resources include display devices, input devices, power management services and system state information. Furthermore, the resource manager 34 is configured to control the accessing of the device hardware 20 by the environments 22, 24. Additionally, the resource manager 34 identifies and controls which user interface associated with the environments 22, 24 is displayed through the GUI of the computing device.

According to the present embodiment, the portal service module 26 is the source of all communications from the first environment 22 to the resource manager 34. Additionally, the portal service module 26 is a sink for all callbacks from the resource manager 34 to the first environment 22. The resource manager 34 provides a status discoverable application programming interface (API) to the portal service module 26. This API is configured to be called by the resource manager 34 at any time. The resource manager 34 is configured to obtain and process run-time status, which allows for the resource manager to maintain a state machine. For the first environment 22, the portal service module 26 provides run-time status to processes that require them. Similarly, the portal service module 26 requests and receives status updates from processes which provide status information (for these reasons, the portal service module 26 can more particularly be considered part of the Android run-time programming 5 of FIG. 2). A similar communication for the second environment 24 is controlled by the resource manager 34, which provides run-time status to the processes that require them. The resource manager 34 requests and receives status updates from various processes that provide status information. The drivers 42 logically associated with the kernel 18 communicate directly with the resource manager 34 as well as the processes that provide run-time status information. By example, the aforementioned API of the resource manager 34 arbitrates access to user interface devices, such as displays, touch screens or the GUI of the computing device. In yet another example, this API arbitrates access to power input devices, such as batteries and/or AC/DC wall plugs.

As mentioned above, the first environment 22 and the second environment 24 are independent from the other in the manner discussed above, and co-exist with respect to the other. Each of the environments 22, 24 is a fully-functioning environment, and does not need the other environment to function, such that the two environments can be said to exist on the mobile device 10 with 100% independence with respect to the other. The first and second environments 22, 24 do not co-exist in a virtualization or emulation scheme, but rather each of the environments operates on the shared, single kernel 18. The first and second environments 22, 24 in particular have run-time coexistence in which both of the environments 22, 24 are run as stand-alone, native environments. Neither of the environments 22, 24 is recompiled, as there is no need to leverage a common C run-time environment. Because of the presence of the two environments 22, 24, a user can access applications 2, 6 that are coded purely for one or the other of the environments 22, 24, and a user can access an application that is coded I′ or one of the environments without an interruption to the user's computing experience with respect to the other of the environments.

In FIG. 4, an additional block diagram shows in schematic form aspects of the operating system 15 (with the Linux user 16 and Linux kernel 18) by which an exemplary co-existence scheme f or the first (Android) environment 22 and the second (Ubuntu) environment 24 is provided. In general, each of the environments 22, 24 operates on a separate run-time environment, which provides software services for programs and/or processes while the mobile device 10 is operating. More particularly as shown, Android processes 46 and Android libraries 48 access a Bionic C (or simply bionic) library 50, which is optimized and modified specifically for the Android environment. The Android libraries 48 and bionic library 50 can be considered to form part of the Android run-time programming 5 of FIG. 2. Additionally as shown, Ubuntu processes 52 and Ubuntu libraries 54 access a GNU C (glibc) library 56, which is used in many standard desktop Linux-based systems. The Ubuntu libraries 54 and glibc library 56 can be considered to form part of the GNU libraries/tools 9 of FIG. 2. Each respective one of the environments 22, 24 runs on its respective C libraries without conflicting with the other one of the environments 22, 24.

In the first environment 22, a server side launcher 60 may start to run when the device 10 is docked for the first time. The server side launcher 60 may be a standalone service or part of the portal service module in FIG. 3. The server side launcher 60 will keep running after started. In the second environment 24, an Android launcher process 66 will be launched when user selects on one of the Android application launcher icons in Application Tray.

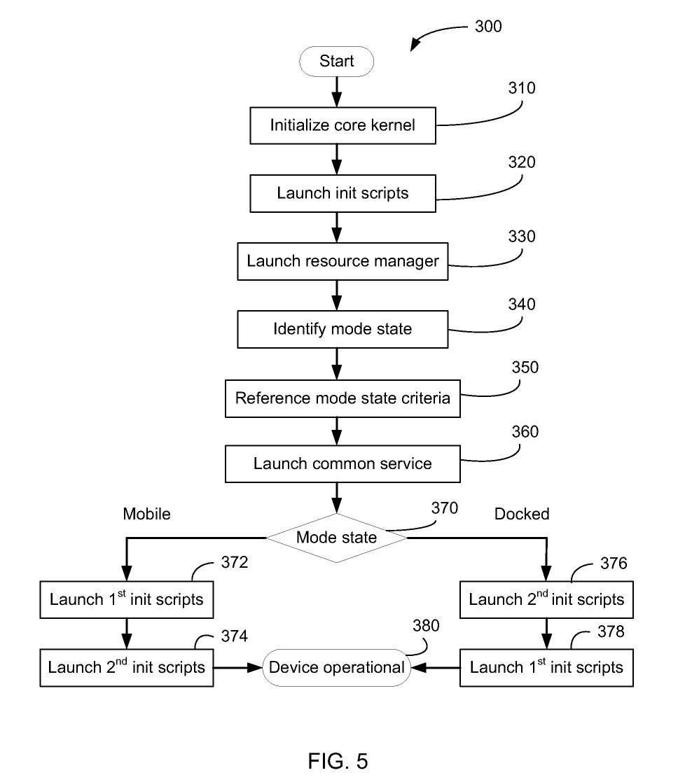

In FIG. 5, a flow chart shows steps of an exemplary boot sequence for the operating system 15 of FIG. 2. The boot sequence includes both common and environment-specific steps. The actual boot sequence is dependent upon rules associated with a predetermined device state of the mobile device 10 that dictates the booting sequence. By example, if the mobile device 10 is connected to a peripheral device, such as a monitor, the device state is considered to be in docked mode, and the second (Linux-based) environment 24 is the default primary environment. Alternatively, if the mobile device 10 is not connected to a peripheral device, then it is in mobile mode, and the first (Android) environment 22 is the default primary environment. Although in any given mode of the mobile device 10 one or the other of the first and second environments 22, 24 serves as a primary environment, both environments are launched simultaneously (that is, the secondary/non-primary environment is launched simultaneously with the primary environment). Further, once both of the environments 22, 24 are launched and one of the environments serves as the primary environment, the secondary environment nevertheless still operates in the background relative to the primary environment, in case the mobile device 10 state changes and the secondary environment is switched to become the primary environment. By example, when the mobile device 10 is in docked mode and the peripheral device is unplugged, there is an automatic switch to mobile mode, which results in the secondary environment becoming the primary environment, and vice versa.

As shown in FIG. 5, the boot sequence is initiated at step 300, followed by the launching/initializing of the Linux kernel 18 (or core) at step 310. In this regard, a bootloader program initializes prior to the launching of the kernel 18. After the Linux kernel 18 is launched/initialized, the kernel itself then launches user space scripts at step 320. The resource manager 34 is further launched at step 330, followed by an identification of the mode state at step 340. Once the mode state is identified, a reference library is accessed at step 350 to determine the criteria associated with and/or dictated by the mode state that is identified. At step 360, services common to both the first environment 22 and the second environment 24 are launched. The mode state determined at step 340 is subsequently referenced and considered at step 370 and, depending upon the mode state, different paths are followed.

In this regard, if at step 370 the mobile mode state is referenced, then the first environment 22 should be the primary environment while the second environment 24 should be the secondary environment. Consequently, in that circumstance, first environment 22 initialization scripts are launched at step 372, followed by the launching of second environment 24 initialization scripts at step 374. Alternatively, if the docked mode state is referenced at step 370, then the second environment 24 should be the primary environment and the first environment 22 should be the secondary environment. Consequently, in that circumstance, second environment 24 initialization scripts are launched at step 376, followed by the launching of first environment 22 initialization scripts at step 378. Following each of the steps 86 and 90, the process in each case proceeds to step 380 at which the mobile device 10 becomes operational. Thus, regardless of which of the environments 22, 24 is the primary environment, both environments are launched and running before the mobile device 10 is operational at step 380. Indeed, since the common services are launched first at step 360, For all intents and purposes the primary and secondary environments are launched in parallel. However, the primary environment-specific services, based upon the device state, are launched immediately before the secondary environment-specific services. By separating the common services launch with the environment-specific launch, the mobile device 10 can be quickly operational with multiple co-existing and independent environments.

Either the first environment 22 or the second environment 24 can be the primary environment. The primary environment may be switched to the secondary environment automatically or by user commands. Simultaneously, the secondary environment will be switched to the primary environment when the primary environment is switched to the secondary environment. Both the first environment 22 and the second environment 24 are running when the mobile device 10 is operational. However, the secondary environment operates in the background relative to the primary environment.

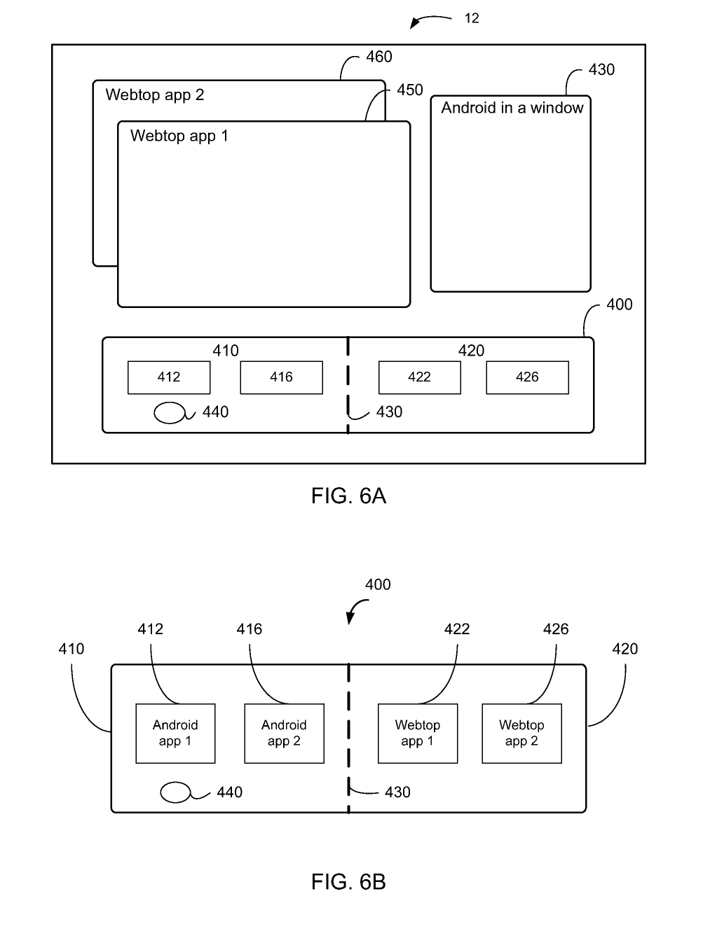

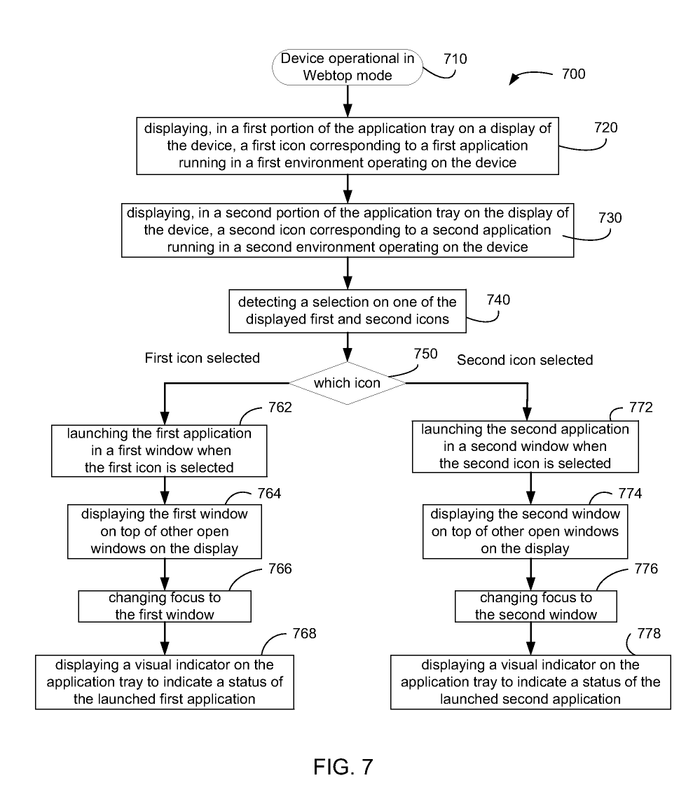

FIG. 6A shows an embodiment of the GUI 12 in the mobile device 10. When the mobile device 10 is docked and the second environment 24 is launched as the primary environment, the mobile devices 10 works in a Webtop mode. In the Webtop mode, all the applications supported by the second environment 24 may be displayed in multiple windows on the GUI 12. These applications are called Webtop applications. By example, the Webtop applications may be a file browser, a web browser, or any other pre-installed or user-installed Webtop applications. At the same time, a user may launch applications supported by the first environment 22 in a single window. By example, a user may launch Android applications in a single window.

In FIG. 6A, there are two launched Webtop application windows 450 and 460 on the GUI 12. Also displayed is an Android in a window (AIW) window 430 where users can navigate to the Android environment. A user may choose to open more Webtop applications or maximize one of the Webtop application windows to take advantage of the full view of the display. As a result, the AIW window may lose focus and be hidden by other open Webtop windows. If the user wishes to make a call or launch other Android applications, the user has to find the AIW window and bring the AIW window on top of the other open windows first. In that case, it would be very difficult for the user to launch Android applications if the Android applications can only be launched within the AIW window.

To help the user to launch Android applications with less time and effort, an application tray 400 is displayed. One embodiment of the application tray 400 is shown in FIG. 6B. The application tray 400 displays Android application launchers 412 and 416 alongside the Webtop applications launchers 422 and 426. By example, the Android application launchers 412 and 416 are displayed in the first portion 410 of the application tray 400. The Webtop application launchers 422 and 426 are displayed in the second portion 420 of the application tray 400. In addition, the application tray 400 may display a visual separator 430 between the first and second portions 410 and 420. The style of the visual separator 430 may be defined and/or changed by the user. The application tray 400 may further display a visual indicator 440 to provide visual indication of the status of the running applications. The user may choose or define the kind of visual effects he/she prefers. For example, the visual indicator 440 may be a small cue under the application launcher icon corresponding to the active application that has focus. Another example of the visual indicator 440 may be a user defined indicator above the active application launcher in the application tray 400.

The shape and location of the application tray 400 may be adjusted and/or defined by the user. For example, the user may choose to break the application tray 400 to two bars by the visual indicator 440. The user may further move the application tray 400 to other locations on the GUI 12.

When one of the Webtop application launchers 422 and 426 is selected, the corresponding Webtop application will be launched in the second environment 24. When one of the Android application launchers 412 and 416 is selected, the corresponding Android application will be launched in the AIW window 430 under the first environment 24. In the second case, the device also changes focus to the AIW window if the AIW window is in a defocused state and raises the AIW window if it is minimized.

FIG. 7 is a flow chart showing steps of displaying the application tray and launching applications when one of the displayed icons is selected according to one embodiment of the disclosure. At step 710, the device 10 is docked and operational in a Webtop mode. The second environment 24 is the primary environment. At step 720, The device 10 displays in a first portion of the application tray on a display of the device 10, wherein a first icon corresponds to a first application running in a first environment operating on the device. At step 730, the device 10 displays, in a second portion of the application tray on the display of the device, wherein a second icon corresponds to a second application running in a second environment operating on the device. At step 740, the device 10 detects a selection on one of the displayed first and second icons. At step 750, the device determines which icon is selected. At step 762, the device 10 launches the first application in an AIW window if the first icon is selected. At step 764, the device 10 displays the first window on top of the other open windows on the display. At step 766, the device 10 changes focus to the first window if the first window does not have focus. Finally, at step 768, the device displays a visual indicator on the application tray to indicate a status of the launched first application.

At step 772, the device 10 launches the second application in a window under the second environment if the second icon is selected. After the selected application is launched, the device 10 displays the second window on top of the other open windows on the display at step 774. At step 776, the device 10 changes focus to the second window if the second window does not have focus. Finally, at step 778, the device displays a visual indicator on the application tray to indicate a status of the launched second application.

For example, the disclosed steps in FIG. 7 may be implemented by a Webtop Intent Framework component that provides APIs for communicating intents between the first and second environments 22 and 24. Specifically, the Webtop Intent Framework component may provide APIs for receiving intents from the first environment to the second environment and sending intents from the second environment to the first environment.

As shown in FIG. 4, the Webtop Intent Framework component includes a server side launcher component 60 that runs in the first environment 22. The server side launcher 60 may be a standalone service or part of the portal service module 26 in FIG. 3. The server side component is started when the device is docked for the first time and it keeps running after that. The Webtop Intent Framework component further includes a client side Android launcher 66 that runs in the second environment 24. The Android launcher 66 passes the parameters required to launch the application to the Webtop Intent Framework when one of the launcher icons is selected. The Webtop Intent Framework then serializes the parameters and sends them to the android side component.

Preferably, the server side launcher component 60 starts when the phone is first docked to prevent the server side component to run when the second environment 24 is not started. This can reduce system load and power consumption. However, the server side launcher component 60 may be started at other time or started by other event. For example, the server side component 60 of intent-framework may be started when the first environment starts.

When a first launch icon corresponding to a first application is selected, the Android launcher 66 takes intent specific parameters as arguments and creates intent and sends the created intent to the first environment via the Webtop Intent Framework. The corresponding application can then be launched with the intent. For example, when the first environment is Android, the executable used is the Android launcher 66 with intent specific data as its parameters. Because all the Android applications are launched within the AIW window, the user may not see the launched application if the AIW window is minimized or out of focus. Thus, the AIW window is raised to the top and granted focus whenever any launcher in the first environment is selected.

The disclosed method may be stored in at least one storage device. The at least one storage device includes computer-readable storage medium that is accessible to at least one processor. The processor is configured to implement the stored instructions to rank and display the disclosed application tray and launch selected application accordingly.

From the foregoing, it can be seen that the present embodiments provide a single launcher that integrates a first and second application launchers from two completely native environments running on a device. The single launcher may have a user defined shape such as a bar at the bottom. One of the novel aspects of the disclosure is the narrow inter-communication to activate applications and report the required launch data to the proper environment. The cost of communication between the two completely different and separate environments running on a single device is very low compared to VM Ware.

It is therefore intended that the foregoing detailed description be regarded as illustrative rather than limiting, and that it be understood that it is the following claims, including all equivalents, that are intended to define the spirit and scope of this invention.

1. A method for displaying an application tray on a device, the method comprising:
displaying, in a first portion of the application tray on a display of the device, a first icon corresponding to a first application running in a first environment operating on the device;
displaying, in a second portion of the application tray on the display of the device, a second icon corresponding to a second application running in a second environment operating on the device;
detecting a selection on one of the displayed first and second icons,
launching the first application in a window when the first icon is selected; and
displaying the window on top of other open windows on the display,
wherein the first environment and the second environment interact with a kernel operating on the device, and
wherein the second environment is a primary environment operating on the device.

2. The method of claim 1, further comprising launching the second application in a second window when the second icon is selected.

3. The method of claim 1, further comprising changing focus to the first window when the first icon is selected and the first window is in a defocused state.

4. The method of claim 1, further comprising displaying a visual separator between the first portion and the second portion of the application tray.

5. The method of claim 1, further comprising displaying a visual indicator on the application tray to indicate a status of the launched first application.

6. The method of claim 1, wherein the first environment comprises a first library.

7. The method of claim 6, wherein the second environment comprises a second library.

8. The method of claim 7, wherein the first environment is configured to execute the first application as a run-time interpreted code on a register-based virtual machine by way of the first library.

9. The method of claim 8, wherein the second environment is configured to execute the second application as a pre-run-time complied code by way of the second library.

10. The method of claim 8, wherein the first library is smaller than the second library.

11. The method of claim 8, wherein the first library is bionic and the second library is glibc.

12. The method of claim 8, wherein the second library is substantially Portable Operating System Interface for Unix (POSIX) compliant.

13. A device comprising:
a display; and
at least one processor configured to interact with the display and perform acts of:
displaying, in a first portion of the application tray on a display of the device, a first plurality of icons corresponding to a first plurality of applications running in a first environment operating on the device;
displaying, in a second portion of the application tray on the display of the device, a second plurality of icons corresponding to a second plurality of applications running in a second environment operating on the device;
launching one of the first plurality of applications in a first window when one of the first plurality of icons is selected; and
displaying the first window on top of other open windows on the display,
wherein the first environment and the second environment interact with a kernel operating on the device, and
wherein the second environment is a primary environment operating on the device.

14. The device of claim 13, wherein the at least one processor is further configured to perform acts of: launching one of the second plurality of applications in a second window when one of the second plurality of icons is selected.

15. The device of claim 13, wherein the at least one processor is further configured to perform acts of: changing focus to the first window when one of the first plurality of icons is selected and the first window is in a defocused state.

16. The device of claim 13, wherein the at least one processor is further configured to perform acts of: displaying a visual separator between the first portion and the second portion of the application tray.

17. The device of claim 13, wherein the at least one processor is further configured to perform acts of: displaying a visual indicator on the application tray to indicate a status of the launched application.

18. The device of claim 13, wherein the first environment includes a first middleware and the second environment includes a second middleware.

19. The device of claim 18, wherein the kernel is a Linux-based kernel, and wherein the kernel interfaces between the device and each of the first and second middleware.

20. The device of claim 18, wherein second environment comprises one of the following desktop environments: GNOME, Enlightenment, Xfce, Fluxbox, LXDE, and KDE.

21. The device of claim 18, wherein the second environment comprises an X11 window manager.

22. The device of claim 13 further comprises an intent framework between the first and second environments, wherein the intent framework receives and sends intents from the second environment to the first environment.

23. The device of claim 13, wherein each of the first plurality of applications runs in the same first window when the corresponding each of the first plurality of icons is selected.

24. The device of claim 13, wherein each of the second plurality of applications runs in different windows when the corresponding each of the second plurality of icons is selected.

25. The device of claim 13, wherein each of the second plurality of applications runs in different windows when the corresponding each of the second plurality of icons is selected.

26. A mobile device comprising:
a display;
at least one processor configured to interact with the display; and
at least one storage device that stores a set of instructions to direct the at least one processor to perform acts of:
displaying, in a first portion of the application tray on a display of the device, a first plurality of icons corresponding to a first plurality of applications running in a first environment operating on the device;
displaying, in a second portion of the application tray on the display of the device, a second plurality of icons corresponding to a second plurality of applications running in a second environment operating on the device;
launching one of the first plurality of applications in a window when one of the first plurality of icons is selected; and
displaying the window on top of other open windows on the display,
wherein the first environment and the second environment interact with a kernel operating on the device, and
wherein the second environment is a primary environment operating on the device.
